(19) United States
(12) Patent Application Publication
(10) Pub. No.: US 2006/0018246 A1
(43) Pub. Date: Jan. 26, 2006

(54) Integrated content and advertising compact disc

(76) Inventor: Douglas H. Kato, Rancho Palos Verdes, CA (US)

Correspondence Address: SMYRSKI LAW GROUP, A PROFESSIONAL CORPORATION, 3310 AIRPORT AVENUE, SW, SANTA MONICA, CA, 90405, US

(21) Appl. No.: 10/897,247

(22) Filed: Jul. 21, 2004

(51) Int. Cl. G11B 7/24

(52) U.S. Cl. 369/275.1

(57) ABSTRACT

A method and apparatus for marketing using a compact disc is provided. The apparatus comprises a compact disc with content, such as music videos, integrated with advertising written thereon. The compact disc may be given away for a nominal fee or free to consumers, and in one aspect of the design an advertiser may pay a fee in exchange for having advertising included on the compact disc, thereby enabling the compact disc producer to give the compact disc to consumers for little or no compensation.

### BACKGROUND OF THE INVENTION

1. Field of the Invention

The present invention relates generally to the field of entertainment and marketing thereof, and more specifically to marketing compact discs containing entertainment and advertising thereon.

2. Description of the Related Art

Compact discs have been available for over two decades. In that time, a variety of information has been provided to end users on compact discs, including but not limited to music, movies, and data. Newer versions of compact discs include CD-R and CD-RW disks, as well as DVDs and DVD-Rs and DVD-RWs. Each of these discs contains digital information and may offer different amounts of storage, accommodating full length movies.

Advertisers have sought to reach target audiences through various means, including placing advertising before film features shown in theaters, using product placement in television shows and movies, and advertising through various communication mediums, including but not limited to broadcast television, radio, billboards, and the internet. However, with the fracturing of television into multiple pay channels and the relatively infinite space on the internet, it becomes more difficult and costly for advertisers to reach a target demographic. Advertisers have looked to new ways of reaching potential consumers, including placing advertisements and products in scenes within video games, among other methods. In essence, advertisers would like to reach a target demographic, say a group of people aged 12-25 or another group aged 48-65, with an appropriate advertising and marketing methodology.

While certain advertisers have distributed compact discs in different settings, all of these distribution products and schemes have had certain drawbacks. For example, certain internet service providers give away compact disks that allow a user to sign up for the ISP's service and contain the needed software to set up an account. These discs are directed to a clear set of persons—those desiring internet access, and the discs only serve that function and that demographic. If the ISP wishes to advertise a product or service, users already signed up for an ISP will not be interested, even if the disc is given away for free. Video game manufacturers sometimes give away discs containing demonstration modules of games, for the purpose of enticing the receiver to purchase the game. Again, this limits the target audience. Music publishers sometimes give away compilations or in limited circumstances music discs for advertising and marketing purposes, but these giveaways are somewhat limited as well. For example, a music publisher giving a consumer a compact disc of an artist's music will lose the sale to that consumer, but hopes that the consumer will buy other music from the artist or publisher. Such giveaways do little to advertise beyond the core product.

Consumers want to receive something of value to them personally, and have interests that may or may not mesh with certain advertisers. For example, a person who enjoys popular music may not be interested in viewing or receiving advertising from an internet service provider or an automobile manufacturer. Advertising to persons who do not have a current interest in a product or service but may develop such an interest in the future provides a value to both the advertiser and the consumer. Thus it would be beneficial to offer a means of advertising broader than those currently available that does not limit advertisers to a particular relatively narrow demographic.

### SUMMARY OF THE INVENTION

According to one aspect of the present invention, there is provided a method and apparatus for marketing using a compact disc is provided. The apparatus comprises a compact disc with content, such as music videos, integrated with advertising written thereon. The compact disc may be given away for a nominal fee or free to consumers, and in one aspect of the design an advertiser may pay a fee in exchange for having advertising included on the compact disc, thereby enabling the compact disc producer to give the compact disc to consumers for little or no compensation.

These and other aspects of the present invention will become apparent to those skilled in the art from the following detailed description of the invention and the accompanying drawings.

### DESCRIPTION OF THE DRAWINGS

The present invention is illustrated by way of example, and not by way of limitation, in the figures of the accompanying drawings in which:

FIG. 1 illustrates production of the compact disc product in accordance with the present design; and

FIG. 2 represents the procedure for advertising using the present design.

### DETAILED DESCRIPTION OF THE INVENTION

As used herein, the term “compact disc” is intended to mean every type of media available capable of transmitting information, including but not limited to CDs, CD-Rs, CD-RWs, DVDs, DVD-Rs, DVD+Rs, DVD-RWs, and DVD+RWs, as well as mini-CDs, or any other media available to receive data usable within a system to play the media containing the data, whether in audio, visual, or data form. Thus removable hard discs, fixed hard discs, floppy discs, and other media may fit within the definition of “compact disc” as the term is used herein.

The present design may include a compact disc having videos located thereon, such as music videos, where select music videos on each compact disc may include advertising in some format. The advertising may be made available for purchase by advertisers wishing to advertise with the music videos offered on the compact disc. The user, when operating the compact disc in some type of compact disc player, computer or computing device, or other playback apparatus, may then be exposed to the advertising when viewing the music videos. The advertising may or may not be content specific, meaning that the advertising may in no way relate to the music video or videos or other content included on the compact disc. The compact disc or compact disc product may be distributed for a very nominal fee, or possibly free of charge.

Compact Disc

The compact disc may be a disc having storage capacity sufficient to hold at least one piece of content, such as a music video, for example a DVD. In the music video context, music videos may be located or written on DVDs using a typical disc writing application, and video editing and disc writing software is currently available that can enable production of a video disc according to the present design. In the current design, the compact disc may include a top level menu, offering selections and possible graphics related to the music videos, allowing a user to select his or her video choice, or play all videos in a sequential order, or some other manner. Video editing software offering this functionality includes but is not limited to products such as Ahead Nero and Roxio Easy CD & DVD Creator 6 or 7. Appropriate menuing functionality may alternately be provided by other commonly available video editing software.

The compact disc may include advertising in various forms, a few embodiments of which will be described here. One method of advertising is simply to include a video advertisement before the video itself, such that a user selecting a video will cause operation in a compact disc player to proceed to the advertisement followed by the selected music video. Alternately, an advertisement may be offered in the music vide itself, such as using a scroll bar or bar at the bottom of the frame, either for the entire video or a portion thereof, or within the frame of the video itself. For example, an advertisement for a soda called “XYZ” may show a revolving XYZ can in one corner of the frame during the entire video or a portion thereof, or simply a see-through version of the “XYZ” logo in one portion of the screen, or moving around the frame while the music video is playing. Products or logos may be superimposed over the video images using video editing software, such as placing an “XYZ” soda can on a table visible in the music video. Other methods of advertising may be employed, such as an audio introduction or voiceover at the beginning of the video, saying “XYZ Soda presents Artist A doing her new song ‘B’.” The end of the video may contain information regarding a web site, where viewers can connect to in order to receive information or further advertising about the artist in the just-viewed video. A disc may offer non-fast forwardable or “must view” space, typically before the menu becomes available, where an advertisement may be inserted. In this arrangement, the user must view the advertisement every time she uses the disc or wishes to play any of the videos in a playback device. Other means or methods of providing advertising may be provided on or with the compact disc as well.

Regarding distribution of advertising, certain advertisements may be placed within or together with particularly popular music videos, with predetermined music videos, or with all music videos on the disc. For example, on a DVD containing twelve music videos, advertising may be included in the second, fifth, eighth, and eleventh music video. A user may select individual videos and avoid the advertising in this arrangement, but the menuing structure may typically provide a “play all” feature, and use of this feature may sequentially play all the videos, thereby providing the advertisements to the viewer. Thus advertising may be provided as selected by the compact disc developer.

Advertising may therefore be included as a simple add-on to the existing video, or may require video editing or processing to include the advertising within or together with the video. This processing may occur prior to writing data to the disc, and once edited, the available data includes the music videos together with the desired advertising in an available form. The arrangement may be thought of as a list, with videos 1-N offered, where N represents an integer quantity of videos employed, and advertising included as additions to certain videos, such as ads placed before a video, or integrated with the video, making the video B into the video B′. The list order might then be, for example: (Intro Ad+Video A), B′, C, (Intro Ad+Video D), E, F, G′, and so forth. Advertisements may also be included as separate entities between music videos, such as A, B, C, Ad1, D, E, F, Ad2, and so forth, where Ad1 is a first advertisement and Ad2 is a second advertisement. The resultant arrangement/list and the associated data may then be used to write the entire selection of videos to the compact disc.

Once the list/arrangement of videos and the menuing structure is established, the videos and advertising information may be written to the disc in a typical sequential disc writing manner, such that the videos and the advertising may be dispersed in data tracks around the compact disc. The advertising is not located in any specific region of the disc using normal disc writing software. The end product is then a compact disc, such as a DVD, having music videos located thereon and available for selection and playing in a compatible device, such as a DVD player, compact disc player, computing device, or otherwise.

While music videos have been discussed herein, it is to be understood that other video, audio, or other information may be provided on the compact disc, such as movie trailers, songs, data, video games, or other advertising information. In these scenarios, different advertising and/or different editing may be required to effectuate the compact disc design provided herein. For example, a music compact disc, including audio only, may be produced with voiceover introduction at the beginning of a song or advertisements placed between songs, requiring sound editing and subsequent compilation using the aforementioned disc writing products.

Distribution and Marketing of the Compact Disc

One use for the compact disc developed according to the foregoing design is use in marketing to target audiences or specific consumer demographics. An entity, such as the compact disc developer, possibly different from the compact disc manufacturer, may approach advertisers and solicit advertising in exchange for payment. Further, the disc developer may solicit music videos, which are typically used as promotional items by music publishers, and may in certain instances be available for very low fees or for free. Once the disc developer has secured music videos, advertising, and a payment arrangement from one or more advertisers, the disc developer may develop the product according to the foregoing compact disc design. Once the compact disc developer has produced the disc, he may give the disc away for a nominal fee or possibly for free to an end user, who receives something of value that includes advertising. The advertiser can reach a target demographic that he might not otherwise have the ability to reach. For example, an automobile manufacturer may have the ability to advertise his automobile to people interested in rap music, or an advertiser may be able to target persons interested in jazz music who might otherwise not be interested in viewing advertising regarding the advertiser's services. As an alternative, the advertiser may act as the compact disc developer and advertise his own products using the music video disc design presented above. All parties receive something of value in the transaction—the advertiser reaches a target audience she might not otherwise reach, the consumer receives a free or nominally priced music video compact disc, and the compact disc developer receives a fee for producing the disc from the advertising fee.

Note that the completed disc may be given to end users in conjunction with a sale or other arrangement, such as a purchase of an item over $5.00 entitles a user to a free music video DVD, or some other type of promotion.

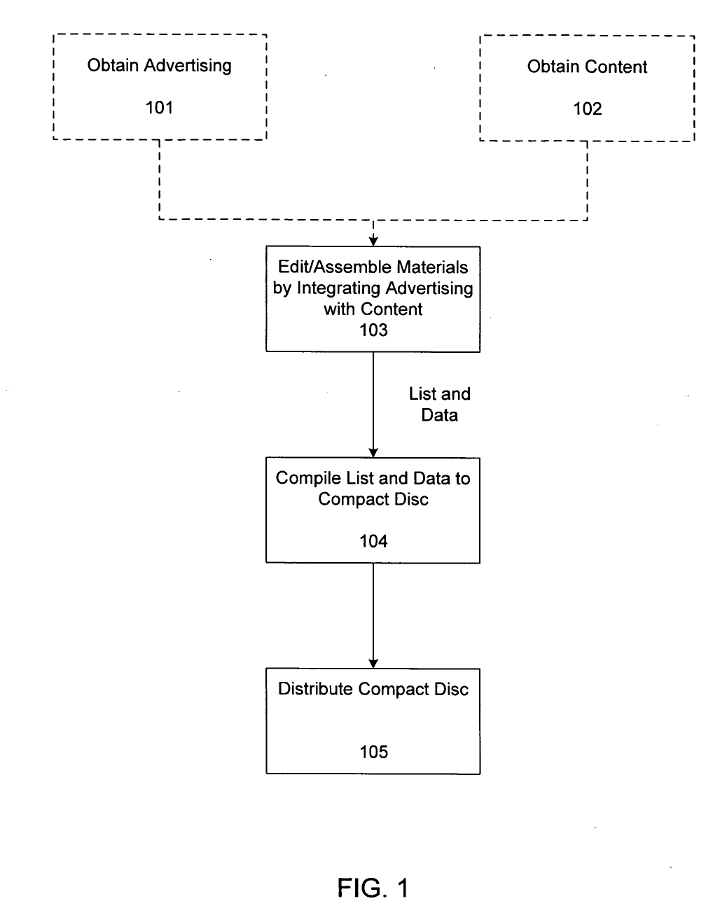

FIG. 1 illustrates the general methodology for compiling a disc. From FIG. 1, the compact disc producer seeks or obtains advertising at point 101, and obtains content, such as music videos or other materials at point 102. Both of these are optional, as the disc producer may have either advertising or other materials available to him or her and not need to seek these items from an outside source. At point 103, the compact disc producer or other entity may edit the materials, including performing sound and video editing to the content to include advertising with or in the content, such as music videos. Output from point 103 is a list of the videos in edited form, again either intact, modified from their original versions, or possibly including augmentations, such as an introductory or closing video advertisement in conjunction with the material, such as a music video. Point 104 compiles the list and data associated with the list onto a compact disc, which is then ready for distribution to end users such as shown by point 105.

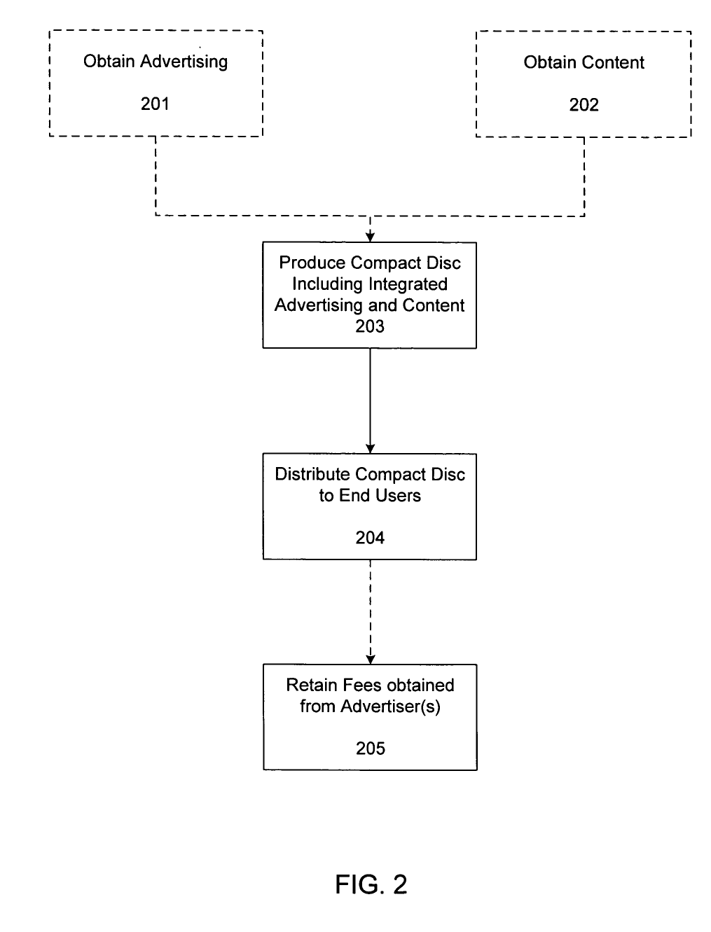

FIG. 2 illustrates the marketing concept associated with the foregoing. From FIG. 2, point 201 contemplates obtaining advertising in exchange for fees, while point 202 obtains content, such as music videos, from content providers, possibly in exchange for fees. Both points 201 and 202 are optional depending on the resources available to the marketing entity, such as the compact disc producer. Point 203 creates the compact disc product as described above, while point 204 distributes the compact disc product to end users, for a nominal fee, together with the purchase of an item, or for free. At point 205, any remaining fees may be maintained by the compact disc product producer, which again is optional.

It will be appreciated to those of skill in the art that the present design may be applied to other systems that perform data processing, and is not restricted to the communications structures and processes described herein. Further, while specific hardware elements and related structures have been discussed herein, it is to be understood that more or less of each may be employed while still within the scope of the present invention. Accordingly, any and all modifications, variations, or equivalent arrangements which may occur to those skilled in the art, should be considered to be within the scope of the present invention as defined in the appended claims.

What is claimed is:

1. A compact disc comprising:
content appealing to a set of consumers; and
advertising integrated with the content.

2. The compact disc of claim 1, wherein the content comprises a plurality of music videos.

3. The compact disc of claim 1, wherein the content comprises a plurality of video clips.

4. The compact disc of claim 1, wherein the advertising comprises video advertising shown within the content.

5. The compact disc of claim 1, wherein the advertising comprises video advertising shown in addition to the content.

6. The compact disc of claim 1, wherein the advertising comprises audio advertising.

7. The compact disc of claim 1, further comprising a menuing structure usable within a compact disc playback device to selectively play the content and integrated advertising in a desired order.

8. The compact disc of claim 7, wherein the content comprises music videos.

9. An advertising method, comprising:
compiling content appealing to a set of consumers;
integrating advertising with the content;
writing the content and advertising to a compact disc; and
providing the compact disc containing the content and advertising to a consumer.

10. The method of claim 9, wherein the content comprises a plurality of music videos.

11. The method of claim 9, further comprising soliciting advertising from at least one advertiser prior to integrating advertising with the content.

12. The method of claim 9, further comprising soliciting content from content providers prior to compiling content.

13. The method of claim 12, wherein the content comprises a plurality of music videos.

14. The method of claim 10, wherein integrating comprises editing the music videos to add the advertising to at least one music video.

15. The method of claim 9, wherein integrating comprises adding advertising to the content to form revised content, and writing comprises writing the revised content to the compact disc.

16. An advertising method, comprising:
producing a compact disc having content and advertising written thereon; and
providing the compact disc to consumers for no fee.

17. The method of claim 16, wherein the content comprises music videos.

18. The method of claim 16, wherein the advertising is integrated with the content on the compact disc.

19. The method of claim 16, further comprising:
soliciting advertising from at least one advertiser; and
producing the compact disc and providing the compact disc in exchange for a fee paid by at least one advertiser.

20. The method of claim 18, wherein advertising is edited into the content to form revised content, and the compact disc includes the revised content.
